(19) United States
(12) Patent Application Publication
(10) Pub. No.: US 2016/0070961 A1
(43) Pub. Date: Mar. 10, 2016

(54) SYSTEM AND METHOD OF PLOTTING SOCIAL NETWORK CONNECTIONS FROM IMAGE DATA

(71) Applicant: ADIENCE SER LTD., Tel Aviv (IL)

(72) Inventors: Eran Hillel EIDINGER, Tel Aviv (IL); Alexander MEDVEDOVSKY, Tel Aviv (IL); Roee NAHIR, Tel Aviv (IL)

(21) Appl. No.: 14/846,849

(22) Filed: Sep. 7, 2015

Related U.S. Application Data
(60) Provisional application No. 62/046,972, filed on Sep. 7, 2014.

(51) Int. Cl. G06K 9/00; G06Q 50/00; G06Q 10/10

(52) U.S. Cl. CPC G06K 9/00677; G06Q 10/10; G06Q 50/01; G06K 2209/27

(57) ABSTRACT

A method of establishing a connection among a plurality of persons according to embodiments of the present invention may include executing instructions by a processor to identify a characteristic that is present in a first image of a portfolio of images and in a second image of the portfolio of images; defining by the characteristic an association of the first image and the second image; and defining a social connection between a first person associated with the first image and a second person associated with the second image. According to some embodiments, a method of identifying a connection between a first person and a second person, may include: receiving, by a computing device, at least one image that may include a data characteristic associated with the first person and with the second person; automatically identifying that the at least one image includes the characteristic; and automatically associating the first person and the second person. Additional methods according to embodiments of the present invention are provided.

### CROSS REFERENCE TO RELATED APPLICATIONS

This application claims the benefit of U.S. Provisional Patent Application Ser. No. 62/046,972, filed on Sep. 7, 2014 (and entitled SYSTEM AND METHOD OF PLOTTING SOCIAL NETWORK CONNECTIONS FROM IMAGE DATA), which is incorporated in its entirety herein by reference.

### BACKGROUND

Electronic devices that have a memory may store significant numbers of images, such as images including people, objects or people with object or other things. Such images may be in one or more of various image collections or portfolios of one or more devices or identifiable services that may be associated with the device or with the services. For example, a gallery or portfolio of images may be stored in a memory of a device, may be stored in one or more applications or identifiable services running on the device (such as Facebook™, WhatsApp™ or other social network applications or other identifiable service) or in a collection of images that are sent to the device form other devices or services. A gallery or portfolio of images may be or include any set or group of images such as for example all or some of the images stored on one or more devices or in the account of one or more users of an identifiable service. Images in one or more galleries or portfolios may be associated with each other or with one or more ideas, places, objects or devices.

### SUMMARY OF THE INVENTION

A method of establishing a connection among a plurality of persons according to embodiments of the present invention may include executing instructions by a processor to identify a first characteristic that is present in a first image of a portfolio of images and in a second image of the portfolio of images; defining by the characteristic an association of the first image and the second image; and defining a social connection between a first person associated with the first image and a second person associated with the second image.

According to some embodiments, the first image and the second image may be substantially the same image, the first image stored on a first device or identifiable service and the second image stored on a second device or identifiable service.

According to some embodiments, a method of identifying a connection between a first person and a second person, may include: receiving, by a computing device, at least one image, the at least one image may include a data characteristic associated with the first person and with the second person; automatically identifying that the at least one image includes the characteristic; and automatically associating the first person and the second person.

According to some embodiments, a method for finding connections between persons, said persons associated with images, may include: instructing a processor to execute instructions to identify at least one object in at least one image from among a portfolio of images, the object may be associated with a first person and associated with one of a second person and a second object, the second object may be associated with the second person; associate the first person with the second person; assign a value to the association of the first person to the second person; and issue a signal if the value exceeds a predefined threshold.

A method of establishing a connection among a plurality of persons according to some embodiments of the present invention may include executing instructions by a processor to identify a first characteristic that is present in a first image of a first portfolio of images and in a first image of a second portfolio of images; defining by the characteristic an association of the first image and the second image; and defining a social connection between a first person associated with the first image and a second person associated with the second image.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of a device in accordance with an embodiment of the invention;

FIG. 2A is a schematic diagram of a first image and a second image according to embodiments of the present invention;

FIG. 2B is a schematic illustration of an association of persons according to embodiments of the present invention; and

FIGS. 3A, 3B and 3C are flowcharts of methods according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### EMBODIMENTS OF THE INVENTION

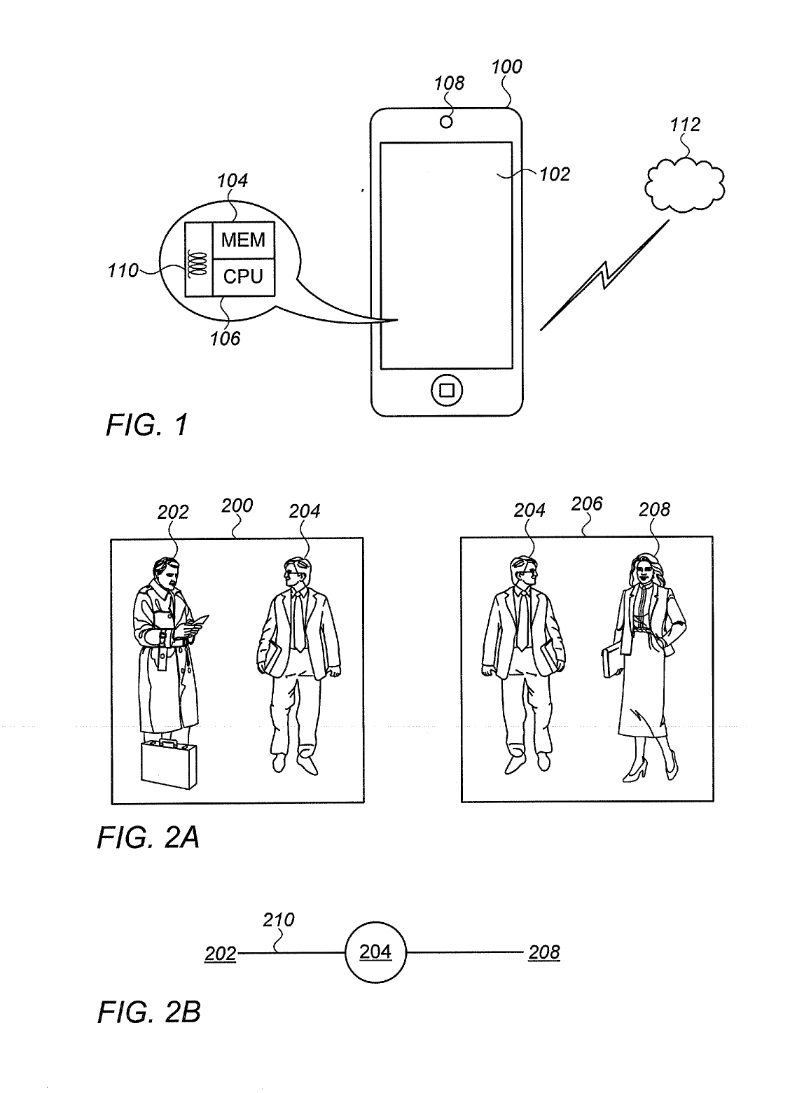

Reference is made to FIG. 1, a schematic diagram of a device in accordance with an embodiment of the invention. Device 100 may include an electronic display or screen 102, one or more units of mass data storage or memory 104, a processor 106 suitable to execute instructions encoded in electronic commands, an imager or camera 108, a communication unit 110 suitable to communicate with a network such as by for example a WiFi, Cellular, Bluetooth or other wired or wireless formats, one or more input devices, such as for example a touch screen or keyboard, and sensors such as accelerometers, heat sensors, light sensors electricity sensors, humidity sensors or other sensors. Device 100 may be or include a cellular telephone, laptop or tablet computer, desktop computer, wearable electronic device, such as for example Google Glass™, clip-on-camera or other electronic device or other devices. Device 100 may be in connection with a network 112 such as the Internet, and may access one or more services such as social network services that may store images or other data that may be accessible to device 100 over the network.

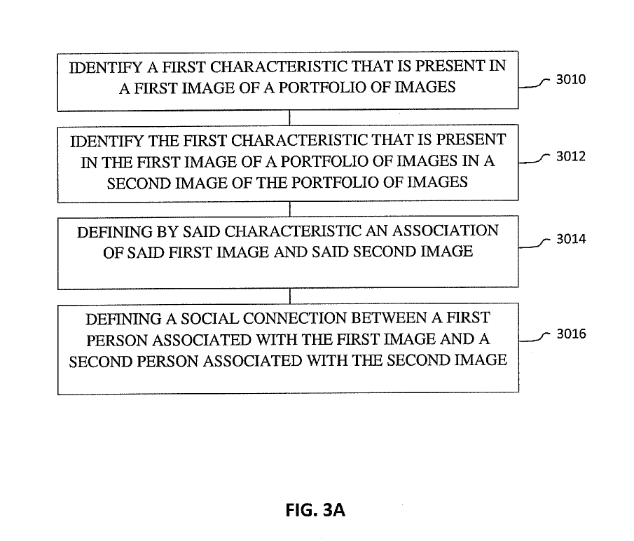

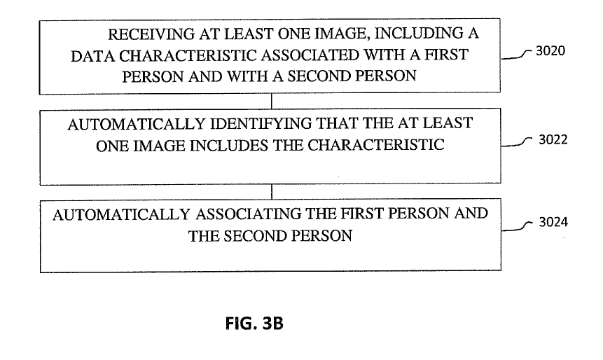

Reference is made to FIG. 2A, a schematic diagram of a first image 200 including one or more figures or persons 202 and 204, a second image 206 including one or more figures of persons 202 and 206. One or more of such images 200 and 206 may be still images or a video images. In some embodiments image 200 may be stored as image data such as pixels in a memory unit such as memory 104, and image 206 may be stored in a same memory 104, in a different memory unit on device 100 or in a memory unit that is located remotely from device 100, but that may be accessible to or associated with device 100 by way of communication unit 110. In some embodiments image 200 may be a still-image or one or more frames of video image. In some embodiments one or more of images 200 and 206 may have been captured by camera 108 and by for example an operator of device 100. In some embodiments, one or more of images 200 and 206 may have been captured by a camera other than camera 108, and transmitted to device 100 by way of for example communication unit 100 and stored on a memory such as memory 104.

In some embodiments, an image such as image 200 may include or be associated with image data in the form of for example pixels (image intrinsic data), as well as with image data associated with the image but that may be not visible in the image (meta-data or image extrinsic data), such as a date or time data of the capture of the image, identification data of the camera that captured the image, data about a rate of compression of the image data, a time of receipt or storage of the image data on device 100 or memory 104, a location (such as by Global Position System or by a transmitter or receiver such as a WiFi receiver that may have been in an area of the device 100 at a time close to when the image was captured) data of the device or camera 108 that captured the image 200 and other data.

In some embodiments, image data representing for example one or more of the faces appearing in images 200 and 206 may be clustered, gathered, compared, analyzed and evaluated by for example a processor, so that for example similar or identical faces, figures or objects that appear in one or more images in the portfolio are tagged, designated or noted as likely representing the same people, places, scenes or things. In some embodiments, a probability or likelihood may be assigned to an assumption or prediction that a face or object in two or more photos represents a same person, object, scene or place.

Referring to FIG. 2B, in some embodiments, one or more associations 210 may be detected, identified or created, and stored in for example a memory or other electronic format, between one or more persons 202 and 204 in an image 200, or between persons 202 and 208 in two or more images 200 and 206, based on for example an association of such persons 202 and 208 by way of their appearance with person 204 in images. Associations 210 between different persons in a same image or in different images may be plotted into for example networks between the persons. For example, a person appearing in an image with many other persons may be deemed a criterion to establish a connection or association between that person and each of the other persons in the image. An appearance of a person in several images with another person may be deemed a criterion to strengthen a connection or association between the people. An appearance of a first person in images over an extended period of time, or in several locations, or with several groups of different people may also be deemed an indication of a strong or strengthened network bond between the people. In some embodiments a time and/or date of receipt of an image by various people (represented by for example their device or designated service account) may be an indication of a social network between them. For example, meta data of an image that indicates that the image was received on three different devices or identifiable services (such as Facebook™) at for example a same or similar time, or that the same or similar image is stored on three different devices, may be deemed sufficient to establish a connection or association between the three devices, on the assumption that each of the devices received the images from the same person or from someone who knows or is otherwise connected to such person. In some embodiments, a capture in a same place at a same or similar time of an image that is stored in different devices may for example be indicative that the people were on the same vacation or that they all know a person who was on the vacation.

Associations may be defined by parameters such as ‘images that include an animal’, ‘images that include a male person’, ‘images that were taken with a particular device’, ‘images captured in a particular period’, or any other parameter(s) that may be applicable to one or more images in a portfolio. Images in a portfolio or gallery may be subject to one or more processing techniques such as for example cropping, tilting, skewing, rotation, white-balance correction, or filtering techniques such as bleaching, histogram equalization or the like, and associations may be created after or as a result of such processing.

An existence of a connection and the strength of such connection may be derived not only from the appearance of the persons in images, but from meta-data of the images, or from a combination of meta-data and intrinsic data. For example if a first image in a portfolio includes meta data indicating that it was captured on Jan. 1, 2014 in Times Square, and a second image in the same or other portfolio indicates that it was captured on Jan. 1, 2014 in Times Square, a relationship may be created between the two images and persons associated with the images. The relationship may be deemed or defined as a weak relationship since many people may have been in the same place at the same time and captured images. The created relationship may be strengthened if for example each of the images includes a face of a particular person.

In some embodiments, a connection may be established between or among two or more people whose image appears in one or more photos in a portfolio of images, and a relative strength of the connections may be raised or lowered depending on for example some of the factors listed above. If the strength of the connections rises to more than a threshold level on the basis or such factors, a decision may be reached, by for example a processor that executes instructions, that such two or more people are in fact connected, and the extent or strength of such connection.

In some embodiments, a connection or relationship may be established based on an item in the image that is not an image of a person. For example, if a first portfolio and a second portfolio each include images of a ski slope, a connection between the owners of the portfolios may be established by their both being skiers, and a social networking group of skiers may be populated by the owners of such portfolios.

In some embodiments a predictive value of a connection between two or more images may be judged or rated by analyzing images through a processor, using the processor to identify the connections in accordance with some of the criteria described above, and then comparing the connections identified by the processor with real world connections or social networks that may be found on for example a social network site.

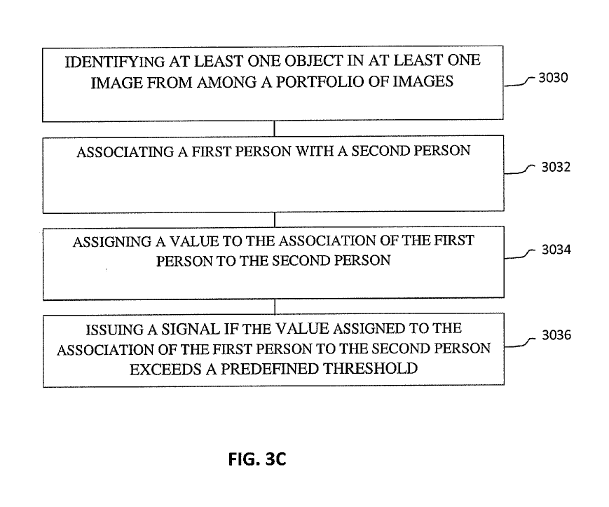

Reference is now made to FIGS. 3A, 3B and 3C which are flowcharts of methods according to some embodiments of the present invention. Embodiments of the invention may include a method of instructing a processor to find, create detect or establish a connection among persons by identifying one or more of a characteristic, object, figure, scene, place that is present in a first image of a portfolio of images and that is present in a second image of the portfolio of images or in the first image. The method may define a relationship or association between the images by or based on for example the characteristic that is present in the two images. As seen in block 3010 a processor, such as CPU 106 in FIG. 1, may identify a first characteristic that is present in a first image of a portfolio of images. As illustrated in block 3012, the processor may further identify the first characteristic that is present in the first image of a portfolio of images in a second image of the portfolio of images. For example, a processor may scan or analyze two images and may find that each of the images includes the Taj Mahal. The processor may create or define an association between the two images based on or defined by the fact that both images include the identified characteristic, such as, for example, the Taj Mahal (see block 3014). As seen in block 3016, the processor may define a social connection between a first person associated with the first image and a second person associated with the second image. For example, the processor may also detect that the first image includes a Person 1 next to the Taj Mahal and that the second image includes a Person 2 next to the Taj Mahal. The processor may associate each of person 1 and person 2 with the Taj Mahal, and may associate person 1 with person 2 where such association is defined by people who appeared in images with the Taj Mahal, or some other definition of the association. The processor may define, detect or create a social connection or network between person 1 and person 2, as a network or people who appeared in images in a portfolio that included the TaJ Mahal, or people who are associated with a device that captured the image or people who are associated with a designated service account that received the image. The processor may analyze the images or metadata of the images to strengthen, weaken or otherwise characterize the depth of the association between the images or persons associated with the images.

As seen in FIG. 3B embodiments of the invention may include a method of instructing a processor to identify, create or find a connection, association or relationship between a first person and a second person by receiving from a storage device at least one image that has a data characteristic that is associated with the first person and the second person. The processor may automatically identify that the image includes the characteristic, and automatically associate the first person and the second person.

As seen in block 3020, according to some embodiments, a method of identifying a connection between a first person and a second person may include receiving, by a computing device, at least one image, the at least one image may include a data characteristic associated with the first person and with the second person.

According to some embodiments, the computing device, such as device 100 in FIG. 1, may automatically identify that the at least one image includes the characteristic (block 3022); and may, according to some embodiments, automatically associate the first person and the second person (block 3024) based on, for example, the characteristic.

According to some embodiments, the processor of computing device such as device 100 in FIG. 1, may be configured to analyze the at least one image to determine strength of the association between the first person and the second person. The strength of the association may be determined as described above with reference to FIGS. 2A and 2B above.

With reference to FIG. 3C, embodiments of the invention may include a method of instructing a processor to find connections between persons that have some association with one or more images or with objects appearing in the image or with metadata of the images. A method may include instructing a processor to identify at least one object in at least one image from among a portfolio of images, where the object is associated with a first person and associated with at least one of a second person and a second object, where the second object is associated with the second person. For example, a first image may include person 1 and the Mona Lisa. A second image may include the Mona Lisa. A processor may associate the person in the first image with a person on whose device is stored the second image. A method may continue to associate the first person with the second person, and to assign a value to the association of the first person to the second person where the value may reflect or measure a strength of the association. The method may issue a signal if the assigned value exceeds a predefined threshold.

As seen in block 3030 the method according to some embodiments may include identifying at least one object in at least one image from among a portfolio of images, the object may be associated with a first person and may be associated with one of a second person and a second object, the second object associated with the second person.

According to some embodiments, the method may further include associating the first person with the second person (block 3032) and assigning a value to the association of the first person to the second person (block 3034).

As seen in block 3036, the method according to some embodiments, may further include issuing a signal if the value assigned to the association of the first person to the second person exceeds a predefined threshold.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of establishing a connection among a plurality of persons, comprising:
executing instructions by a processor to identify a first characteristic that is present in a first image of a portfolio of images and in a second image of said portfolio of images;
defining by said characteristic an association of said first image and said second image; and
defining a social connection between a first person associated with said first image and a second person associated with said second image.

2. The method as in claim 1, wherein said first image and said second image are a substantially same image, said first image stored on a first device or identifiable service and said second image stored on a second device or identifiable service.

3. The method according to claim 1 wherein said processor is configured to analyze the images to determine strength of the association between the images or between persons associated with the images.

4. The method according to claim 1 wherein said processor is configured to analyze metadata of the images to determine strength of the association between the images or between persons associated with the images.

5. A method of identifying a connection between a first person and a second person, comprising:
receiving, by a computing device, at least one image, said at least one image including a data characteristic associated with said first person and with said second person;
automatically identifying that said at least one image includes said characteristic; and
automatically associating said first person and said second person.

6. The method according to claim 5 wherein the computing device is configured to analyze the at least one image to determine strength of the association between the first person and the second person.

7. The method according to claim 5 wherein the computing device is configured to analyze metadata of the at least one image to determine strength of the association between the first person and the second person.

8. A method for finding connections between persons, said persons associated with images, the method comprising:
instructing a processor to execute instructions to
identify at least one object in at least one image from among a portfolio of images, said object associated with a first person and associated with one of a second person and a second object, said second object associated with said second person;
associate said first person with said second person;
assign a value to said association of said first person to said second person; and
issue a signal if said value exceeds a predefined threshold.

9. A method of establishing a connection among a plurality of persons, comprising:
executing instructions by a processor to identify a first characteristic that is present in a first image of a first portfolio of images and in a first image of a second portfolio of images;
defining by said characteristic an association of said first image and said second image; and
defining a social connection between a first person associated with said first image and a second person associated with said second image.

10. The method as in claim 9, wherein said first image and said second image are a substantially same image, said first image stored on a first device or identifiable service and said second image stored on a second device or identifiable service.

11. The method according to claim 9 wherein said processor is configured to analyze the images to determine strength of the association between the images or between persons associated with the images.

12. The method according to claim 9 wherein said processor is configured to analyze metadata of the images to determine strength of the association between the images or between persons associated with the images.
